(19) United States
(12) Patent Application Publication
(10) Pub. No.: US 2018/0308161 A1
(43) Pub. Date: Oct. 25, 2018

(54) TRADING INFORMATION PROVIDING SYSTEM THAT PROVIDES TRADING INFORMATION PROVIDED BY PLURAL FINANCIAL INSTITUTIONS TO BUSINESS OPERATOR, SERVER APPARATUS, AND NODE APPARATUS

(71) Applicant: The Bank of lwate, Ltd., Morioka (JP)

(72) Inventors: Junya Sekimura, Morioka (JP); Masatoshi Shimizu, Morioka (JP)

(21) Appl. No.: 15/954,020

(22) Filed: Apr. 16, 2018

(30) Foreign Application Priority Data
Apr. 20, 2017 (JP) 2017-083703
Mar. 8, 2018 (JP) 2018-042248

(51) Int. Cl. G06Q 40/04; H04L 29/08

(52) U.S. Cl. CPC G06Q 40/04; G06Q 40/02; H04L 67/10

(57) ABSTRACT

A trading information providing system includes a plurality of node apparatuses managed by different financial institutions, a server apparatus, and a user terminal. Each of the plurality of node apparatuses comprises a storage device configured to hold both trading information of a user in a financial institution that manages the node apparatus and trading information of the user in a financial institution that does not manage the node apparatus. The server apparatus comprises at least one processor or circuit configured to: receive, from the user terminal of the user, a request for the trading information of the user; acquire trading information according to the request from at least one of the plurality of node apparatuses; and transmit a response to the user terminal, the response including the trading information of the user in at least two financial institutions.

### CROSS-REFERENCE TO RELATED APPLICATIONS

This application claims priority to Japanese Application Serial No. 2017-083703, having the title “IMAGE FORMING APPARATUS AND MANAGEMENT SYSTEM,” filed on Apr. 20, 2017 and also claims priority to Japanese Application Serial No. 2018-042248, having the title “METHOD AND APPARATUS FOR ASSOCIATING A RELAY IN WIRELESS COMMUNICATIONS,” filed on Mar. 8, 2018, the disclosures of which are incorporated herein by reference in their entirety.

### BACKGROUND OF THE INVENTION

### Field of the Invention

The present invention relates to a trading information providing system that provides trading information provided by a plurality of financial institutions to a business operator, a server apparatus, and a node apparatus.

### Description of the Related Art

There is conventionally known a system that makes a user access a web site provided by a financial institution such as a bank and browse financial trading information or an account transfer state provided by the financial institution.

Such a browsing service via the Internet is very convenient. However, if a plurality of institutions provide services, the user needs to individually access the services, resulting in cumbersome access to web sites. Japanese Patent Laid-Open No. 2006-215904 discloses a technique in which if a user who has accessed a web site on the side of a financial institution such as a bank desires a trading order of a financial product or the like, a session with the user terminal is automatically switched from a web server on the bank side to the side of the web server of a security dealer.

A business operator (also simply called a user) sometimes receives similar services (for example, account transfer) provided by a plurality of financial institutions. When browsing the information of the services, the user is able to receive the states of the services by the plurality of financial institutions at once.

The technique disclosed in Japanese Patent Laid-Open No. 2006-215904 described above facilitates switching between the services by the plurality of financial institutions but does not consider providing the services by the plurality of financial institutions at once.

In addition, a system that supports the service of a financial institution needs to implement maintenance of concealment and reduction of risks to system failures at high level. For this reason, each financial institution needs to independently construct a system and bear a high system construction cost and operation cost.

That is, a system that allows a plurality of financial institution to share a system and reduce burdens in maintenance and operation and can provide pieces of trading information provided by the plurality of financial institutions to a user at once is useful for both the user and the financial institutions.

### SUMMARY OF THE INVENTION

The present invention has been made in consideration of the aforementioned problems, and has as its object to implement a technique that allows a plurality of financial institution to share a system and can provide pieces of trading information provided by the plurality of financial institutions to a user at once.

In order to solve the aforementioned problems, one aspect of the present invention provides a trading information providing system including a plurality of node apparatuses, a server apparatus, and a user terminal, wherein the plurality of node apparatuses are a plurality of node apparatuses managed by different financial institutions, and each of the plurality of node apparatuses comprises: a storage device configured to hold both trading information of a user in a financial institution that manages the node apparatus and trading information of the user in a financial institution that does not manage the node apparatus; and at least one processor or circuit configured to perform the operations of following units: a node reception unit configured to receive, from the server apparatus, a first acquisition request for the trading information of the user who has a trading account in a financial institution of the plurality of financial institutions; a read unit configured to read out, from the storage device, trading information according to the first acquisition request received by the node reception unit; and a node transmission unit configured to transmit the trading information of the user read out by the read unit to the server apparatus, wherein the server apparatus comprises: at least one processor or circuit configured to perform the operations of following units: a server reception unit configured to receive, from the user terminal of the user, a second acquisition request for the trading information of the user; an acquisition unit configured to acquire trading information according to the second acquisition request from at least one of the plurality of node apparatuses using the first acquisition request in accordance with reception of the second acquisition request by the server reception unit; and a server transmission unit configured to transmit the acquired trading information according to the second acquisition request to the user terminal as a response, and wherein the server transmission unit transmits the response including the trading information of the user in at least two financial institutions to the user terminal.

Another aspect of the present invention provides, a server apparatus configured to communicate with a plurality of node apparatuses managed by different financial institutions and configured to hold both trading information of a user in a financial institution that manages the node apparatus and trading information of the user in a financial institution that does not manage the node apparatus, comprising: at least one processor or circuit configured to perform the operations of following units: a reception unit configured to receive an acquisition request for the trading information of the user from a user terminal of the user who has a trading account in a financial institution of a plurality of financial institutions; an acquisition unit configured to acquire the trading information according to the acquisition request from at least one of the plurality of node apparatuses in accordance with reception of the acquisition request; and a transmission unit configured to transmit the acquired trading information according to the acquisition request to the user terminal as a response, and wherein the transmission unit transmits the response including the trading information of the user in at least two financial institutions to the user terminal.

Still another aspect of the present invention provides, a method of controlling a server apparatus configured to communicate with a plurality of node apparatuses that are managed by different financial institutions and that are configured to hold both trading information of a user in a financial institution that manages the node apparatus and trading information of the user in a financial institution that does not manage the node apparatus, comprising: receiving an acquisition request for the trading information of the user from a user terminal of the user who has a trading account in a financial institution of a plurality of financial institutions; acquiring the trading information according to the acquisition request from at least one of the plurality of node apparatuses in accordance with reception of the acquisition request; and transmitting the acquired trading information according to the acquisition request to the user terminal as a response, wherein in the transmitting, the response including the trading information of the user in at least two financial institutions is transmitted to the user terminal.

Yet another aspect of the present invention provides, a node apparatus in a system including a plurality of node apparatuses managed by different financial institutions and configured to hold both trading information of a user in a financial institution that manages the node apparatus and trading information of the user in a financial institution that does not manage the node apparatus, and a server apparatus configured to, in accordance with reception of an acquisition request for the trading information of the user from a user terminal of the user who has a trading account in a financial institution of a plurality of financial institutions, acquire trading information according to the acquisition request from at least one of the plurality of node apparatuses and transmit a response including the trading information of the user in at least two financial institutions to the user terminal, comprising: a storage device configured to hold both the trading information of the user in the financial institution that manages the node apparatus and the trading information of the user in the financial institution that does not manage the node apparatus; and at least one processor or circuit configured to perform the operations of following units: a reception unit configured to receive, from the server apparatus, the acquisition request for the trading information of the user; a read unit configured to read out, from the storage device, the trading information according to the acquisition request received by the reception unit; and a transmission unit configured to transmit the trading information of the user read out by the read unit to the server apparatus.

Still yet another aspect of the present invention provides, a method of controlling a node apparatus in a system including a plurality of node apparatuses managed by different financial institutions and configured to hold both trading information of a user in a financial institution that manages the node apparatus and trading information of the user in a financial institution that does not manage the node apparatus, and a server apparatus configured to, in accordance with reception of an acquisition request for the trading information of the user from a user terminal of the user who has a trading account in a financial institution of a plurality of financial institutions, acquire trading information according to the acquisition request from at least one of the plurality of node apparatuses and transmit a response including the trading information of the user in at least two financial institutions to the user terminal, comprising: holding both the trading information of the user in the financial institution that manages the node apparatus and the trading information of the user in the financial institution that does not manage the node apparatus; receiving, from the server apparatus, the acquisition request for the trading information of the user; reading out, from the held trading information, the trading information according to the received acquisition request; and transmitting the readout trading information of the user to the server apparatus.

According to the present invention, it is possible to allow a plurality of financial institution to share a system and provide pieces of trading information provided by the plurality of financial institutions to a user at once.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIGS. 1A and 1B are views for explaining the outline of a trading information providing system according to an embodiment of the present invention;

FIGS. 2A and 2B are block diagrams showing the hardware arrangements of a server apparatus, a node apparatus, and a client apparatus according to the embodiment;

FIG. 3 is a view for explaining an example of the functional arrangements of the server apparatus, the node apparatus, and the client apparatus according to the embodiment;

FIG. 4 is a flowchart showing a series of operations of a server apparatus 101 concerning display of account transfer data and registration of new account transfer data by a user;

FIGS. 5A and 5B are views showing examples of a login screen and a menu screen displayed on the client apparatus of the user;

FIGS. 6A and 6B are views showing examples of an account transfer processing list and an account transfer particular list displayed on the client apparatus of the user;

FIG. 7 is a view showing an example of a new request registration screen displayed on the client apparatus of the user;

FIG. 8 is a flowchart for explaining a series of operations of the server apparatus 101 concerning download of account transfer data and registration of processing result data by a financial institution;

FIGS. 9A and 9B are views showing examples of management screen login and a management menu displayed on the client apparatus of the financial institution;

FIGS. 10A and 10B are views showing examples of a management target account transfer processing list and a lock screen displayed on the client apparatus of the financial institution;

FIG. 11 is a view showing an example of processing result upload displayed on the client apparatus of the financial institution;

FIGS. 12A and 12B are views showing an example of a bank statement output screen and an example of a bank statement displayed on the client apparatus of the financial institution; and

FIG. 13 is a view showing an example of the arrangement of a trading information providing system according to another embodiment.

### DESCRIPTION OF THE EMBODIMENTS

### First Embodiment

An exemplary embodiment of the present invention will now be described in detail with reference to the accompanying drawings.

(Outline of Arrangement and Operation of System)

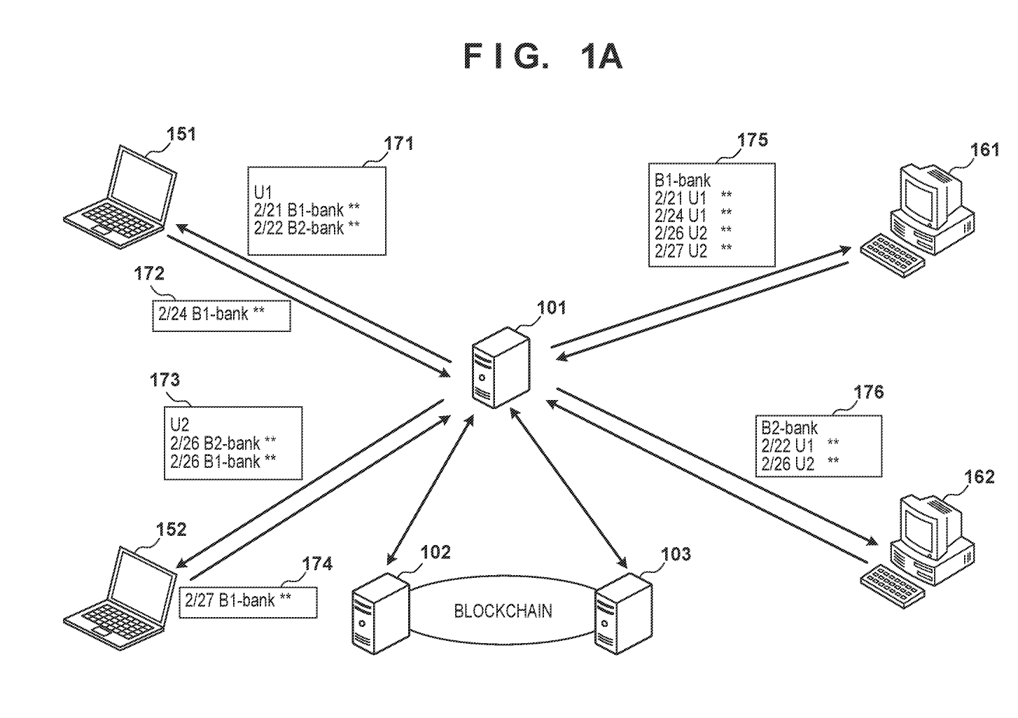

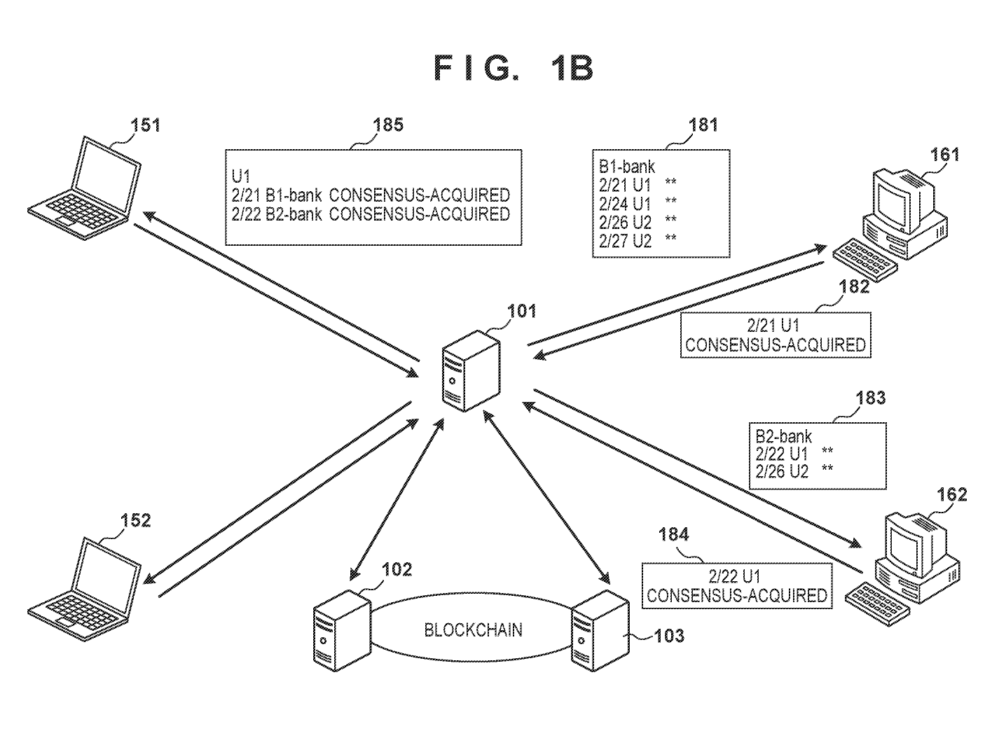

FIG. 1A is a view for explaining a trading information providing system as an example of an information processing system according to this embodiment. Note that at least one server apparatus, at least one client apparatus, and at least one node apparatus, which constitute the trading information providing system shown in FIG. 1A, may be implemented by pieces of independent physical hardware or may be implemented by a virtual machine virtually implemented by executing software. When these apparatuses are virtually implemented, a plurality of virtual machines may be executed on one piece of hardware or may be implemented on different pieces of hardware. In addition, at least one of these apparatuses may be implemented using two or more pieces of hardware.

(Outline of System and Operation Thereof)

A server apparatus 101 intervenes between a client apparatus 151 managed by a business operator (user) or a client apparatus 161 managed by a financial institution (including a business operator that runs a financial business) and node apparatuses 102 and 103 that constitute a P2P network on a blockchain, and transmits/receives necessary data to/from the node apparatuses and replies with data in response to a request from the client apparatus. Note that in the following example, a description will be made assuming that a user has trading accounts in a plurality of financial institutions.

Each of the node apparatuses 102 and 103 is a computer managed by a specific financial institution. Each node apparatus forms a node on the P2P network that constitutes the blockchain and possesses a distributed ledger on the blockchain. To implement management of the distributed ledger by the blockchain, each node apparatus operates software for providing a blockchain service such as Hyperledger Fabric. In this embodiment, account transfer data is recorded in a distributed ledger on the blockchain and shared by distributed ledgers possessed by a plurality of node apparatuses. That is, a distributed ledger possessed by the node apparatus 102 managed by a financial institution B1 can hold both account transfer data of a user in the financial institution B1 and account transfer data of the user in another financial institution (for example, a financial institution B2). However, the node apparatus 102 can control encryption/decryption of the data of the distributed ledger using the encryption key of each financial institution managed by a management server (not shown) or node apparatus. Hence, even if the distributed ledger possessed by the node apparatus 102 holds data of another financial institution, the financial institution B1 can be inhibited from browsing the account transfer data of the other financial institution.

The client apparatus 151 is a user terminal, for example, a personal computer used by a business operator (user) U1 who entrusts account transfer works to financial institutions. For example, assume that the user U1 entrusts the account transfer works to the financial institutions B1 and B2 and manages the client apparatus 151. In this case, the user U1 can newly register account transfer data of the user U1 in the entrusted financial institutions B1 and B2 or browse already registered account transfer data of the user U1 via the client apparatus 151. A client apparatus 152 is managed by, for example, a user (business operator) U2 different from the user U1, and transmits/receives the account transfer data of the user U2, like the client apparatus 151.

The client apparatus 161 is a user terminal, for example, a personal computer used by a financial institution. For example, assume that the financial institution B1 manages the client apparatus 161. In this case, the financial institution B1 can download account transfer data on the blockchain via the client apparatus 161. In addition, the financial institution B1 can input the downloaded account transfer data to a centralized management system (not shown in FIG. 1) that separately exists in each financial institution, and actually execute the account transfer processing. Furthermore, the financial institution B1 can register the result of the account transfer processing performed by the centralized management system in the blockchain as processing result data via the client apparatus 161. Note that a client apparatus 162 is managed by, for example, the financial institution B2 different from the financial institution B1, and transmits/receives account transfer data associated with the financial institution B2, like the client apparatus 161.

The outline of the operation of the system in a case in which the user browses account transfer data and registers new account transfer data will be described next. Upon receiving access from the client apparatus 151 handled by the user U1, the server apparatus 101 acquires account transfer data already registered by the user U1 from node apparatuses on the blockchain for a plurality of financial institutions (B1 and B2). The server apparatus 101 then transmits a web page to display part (for example, account transfer data 171) of the account transfer data of the user U1 and a new registration button for data to the client apparatus 151. The account transfer data 171 includes the account transfer data of the user U1 in the financial institutions B1 and B2.

By pressing the new registration button of the web page on the client apparatus 151, the user U1 can register new account transfer data in the financial institutions. For example, the client apparatus 151 transmits new registration data 172 to the server apparatus 101. The new registration data 172 includes, for example, account transfer data associated with the financial institution B1 for the user U1. Upon receiving the new registration data from the client apparatus 151, the server apparatus 101 transmits the new registration data to the node apparatus 102 to register it in the distributed ledger on the blockchain. The node apparatus 102 writes the received new registration data in a block on the blockchain.

If the authenticity of the new registration data written in the block on the blockchain by the node apparatus 102 is confirmed by the processing of a consensus algorithm executed on the blockchain, the data becomes consensus-acquired data. After that, the consensus-acquired data is recorded in the distributed ledgers possessed by the node apparatuses (including the node apparatus 103) on the blockchain. That is, the new registration data is held by the distributed ledger of each of the node apparatus 102 managed by the financial institution B1 and the node apparatus 103 managed by the financial institution B2.

After that, the server apparatus 101 acquires part of the account transfer data including the consensus-acquired new registration data from the node apparatus 102, and transmits a web page to display the account transfer data and a new registration button for the data to the client apparatus 151. In this case, the account transfer data includes the newly registered processing of February 24.

Note that the server apparatus 101 performs the same processing as the above-described processing even for an operation performed by the user U2 using the client apparatus 152. For example, the server apparatus 101 reads out the account transfer data of the user U2 from the distributed ledger on the blockchain via the node apparatus 103 and displays it as account transfer data 173. In addition, the server apparatus 101 records, via the node apparatus 103, new registration data 174 of the user U2 in the distributed ledger possessed by the node apparatus 103. That is, the server apparatus 101 records the new registration data 174 of the user U2 in the distributed ledgers possessed by the node apparatuses 102 and 103 on the blockchain.

The outline of the operation of the system in a case in which the financial institution downloads the account transfer data of a plurality of users recorded in the distributed ledgers on the blockchain will be described next. Upon receiving access from the client apparatus 161 managed by the financial institution B1, the server apparatus 101 transmits an acquisition request of account transfer data (to be processed by the financial institution B1) to the node apparatus 102 managed by the financial institution B1. The node apparatus 102 returns account transfer data accessible by the financial institution B1 (that is, account transfer data to be managed by the financial institution B1) to the server apparatus 101. The account transfer data returned from the node apparatus 102 includes the account transfer data of a plurality of users which are not processed by the centralized management system of the financial institution B1. The server apparatus 101 transmits the unprocessed data (for example, account transfer data 175) of the plurality of users to the client apparatus 161 at once. Note that the client apparatus 162 can also download, for a plurality of users, unprocessed account transfer data (for example, account transfer data 176) to be processed by the financial institution B2.

The outline of the operation of the system in a case in which processing result data for which processing of account transfer is completed by the centralized management system of the financial institution is uploaded to the blockchain will be described next with reference to FIG. 1B.

Upon receiving access from the client apparatus 161 managed by the financial institution B1, the server apparatus 101 acquires account transfer data associated with the financial institution B1 from the node apparatus 102 on the blockchain. The server apparatus 101 then transmits a web page to display part (for example, account transfer data 181) of the account transfer data to be processed by the financial institution B1 and a processing result data upload button to the client apparatus 161. When the processing result data registration button displayed on the web page is pressed, the client apparatus 161 transmits processing result data (for example, account transfer data 182) output from the centralized management system to the server apparatus 101.

The server apparatus 101 transmits the processing result data received from the client apparatus 161 to the node apparatus 102 on the blockchain and records the data as a block. If the authenticity of the recorded processing result data is confirmed by the processing of the consensus algorithm executed on the blockchain, the data becomes consensus-acquired data. The consensus-acquired processing result data is recorded in the distributed ledgers of the node apparatuses (including the node apparatus 103) on the blockchain.

Note that as for the account transfer data of the financial institution B2 as well, the server apparatus 101 transmits unprocessed account transfer data 183 to the client apparatus 162, as in the case of the financial institution B1. Upon receiving account transfer data (184) processed by the centralized management system of the financial institution B2, the server apparatus 101 registers the account transfer data on the blockchain via the node apparatus 103.

On the other hand, upon receiving a request from the client apparatus 151, the server apparatus 101 acquires account transfer data including consensus-acquired processing result data from the node apparatus 102 and transmits the data (account transfer data 185) to the client apparatus 151. At this time, the account transfer data that the server apparatus 101 acquires from the node apparatus includes processing result data newly registered by the financial institutions B1 and B2. In this way, according to the trading information providing system of this embodiment, a plurality of financial institutions share the system, and a user can acquire account transfer data in the financial institutions to which the account transfer is entrusted at once.

(Arrangement of Server Apparatus 101)

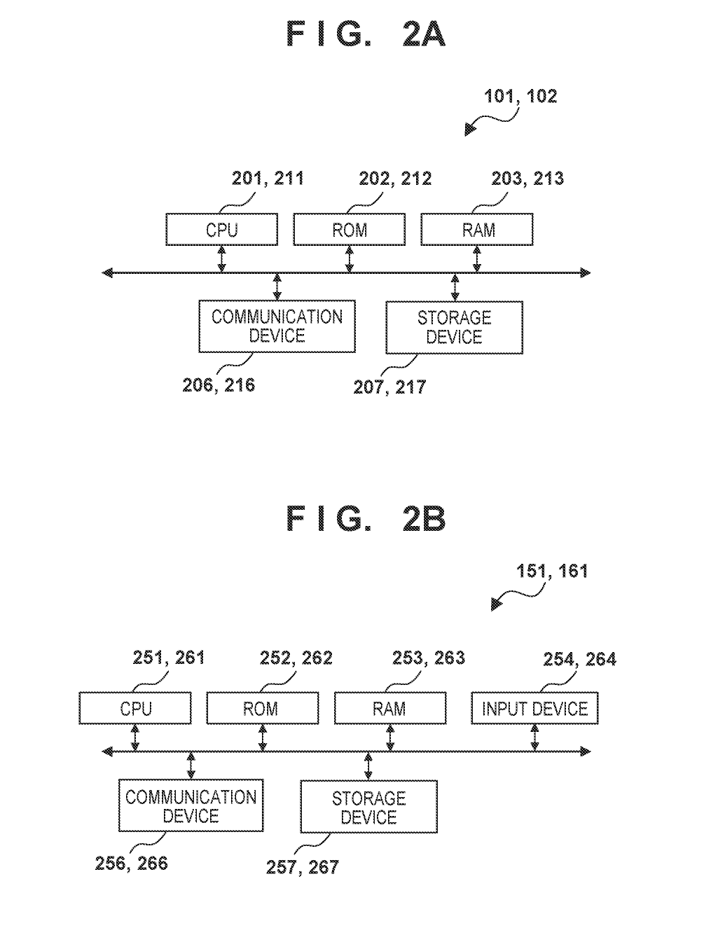

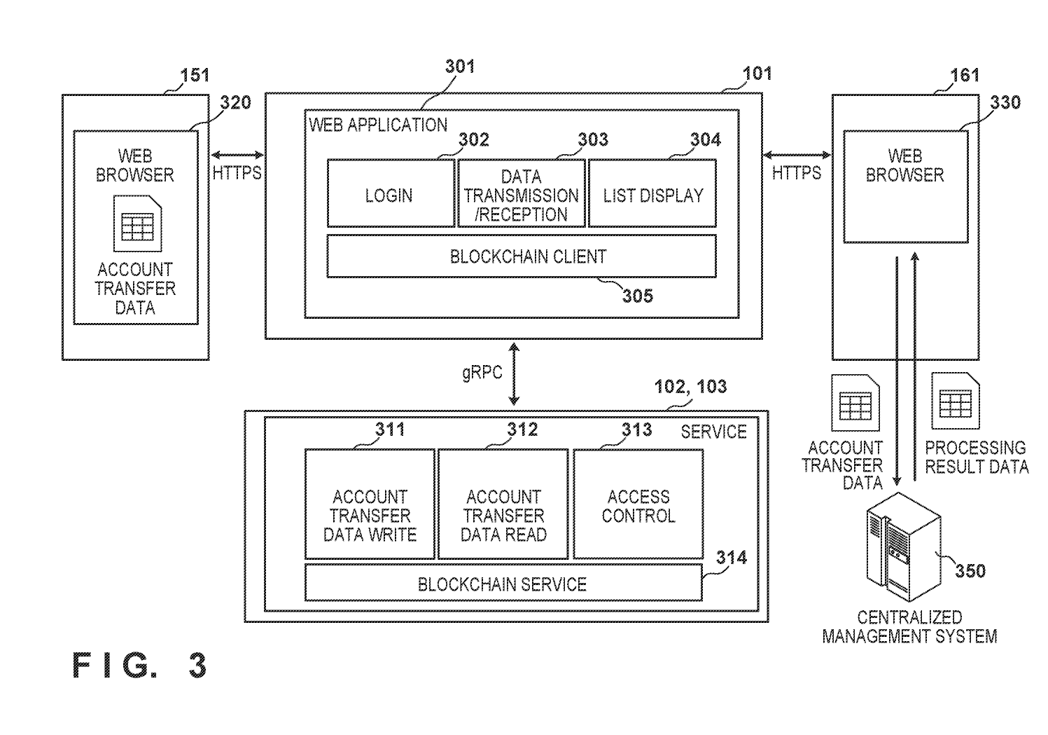

An example of the functional arrangement of the server apparatus 101 will be described next with reference to FIGS. 2A and 3.

A CPU 201 executes programs recorded in a ROM 202 or a storage device 207, thereby implementing the functions of the server apparatus 101 in the trading information providing system shown in FIG. 1.

The programs include a web application configured to operate the server apparatus 101 as a web application server. As shown in 301 of FIG. 3, the web application includes, for example, a login module 302 that processes login of a user, a data transmission/reception module 303 that controls transmission/reception of data to/from the client apparatus 151 or 161, a list display module 304 that provides an account transfer data list display function. The web application also includes a blockchain client module 305 that performs communication with the node apparatuses 102 and 103 forming the blockchain and operates as a client of the blockchain.

The ROM 202 includes a nonvolatile memory such as a semiconductor memory and stores programs to be executed by the CPU 201, set values of the server apparatus 101, and the like. A RAM 203 includes, for example, a volatile memory such as an SDRAM and temporarily stores a calculation result of the CPU 201 and the like.

A communication device 206 transmits/receives commands and data between the client apparatus 151 or 161 and the node apparatuses 102 and 103. The communication device 206 exchanges data with the client apparatus 151 by communication based on, for example, HTTPS. In addition, the communication device 206 transmits/receives data to/from the node apparatuses 102 and 103 by communication based on, for example, gRPC protocol. The storage device 207 includes, for example, a semiconductor memory such as an SSD or a magnetic disk such as an HDD and stores data necessary for the operation of the web application.

(Arrangement of Node Apparatuses 102 and 103)

An example of the functional arrangement of the node apparatuses 102 and 103 is the same as the example of the functional arrangement of the server apparatus 101 except that the programs operating on the server apparatus 101 are different. Each of the node apparatuses 102 and 103 includes a CPU 211, a ROM 212, a RAM 213, a communication device 216, and a storage device 217. Programs executed by the CPU 211 of the node apparatus include a service program that implements the blockchain. For example, Hyperledger Fabric operates. The service program includes an account transfer data write module 311 that writes account transfer data in the distributed ledger held by the storage device 217 of each node apparatus, an account transfer data read module 312 that reads out data from the ledger, an access control module 313 that controls access by a user or a financial institution in accordance with an access right, and the like. A blockchain service 314 executes the consensus algorithm to be performed when adding a transaction or executes processing such as synchronization of data of distributed ledgers between the node apparatuses. The storage device 217 holds the data of the distributed ledger written or read by execution of the service program, and account transfer data is recorded in the distributed ledger. The account transfer data is stored in a block of a predetermined size and sequentially recorded in the distributed ledger.

(Arrangement of Client Apparatus 151)

An example of the functional arrangement of the client apparatus 151 will be described next with reference to FIGS. 2B and 3.

A CPU 251 executes programs recorded in a ROM 252 or a storage device 257, thereby implementing the functions of the client apparatus 151 in the trading information providing system shown in FIG. 1. The programs include a web browser 320 configured to operate the client apparatus 151 as a web client. The web browser 320 transmits/receives data such as account transfer data to/from the server apparatus 101.

The ROM 252 includes a nonvolatile memory such as a semiconductor memory and stores programs to be executed by the CPU 251, set values of the client apparatus 151, and the like. A RAM 253 includes, for example, a volatile memory such as an SDRAM and temporarily stores a calculation result of the CPU 251 and the like.

An input device 254 includes, for example, a keyboard, a mouse, or a touch panel that enables the operation of screen transition of the web browser or selection of a file to be uploaded. A communication device 256 transmits/receives commands and data to/from the server apparatus 101.

(Arrangement of Client Apparatus 161)

An example of the functional arrangement of the client apparatus 161 will be described next with reference to FIGS. 2B and 3. A CPU 261 executes programs recorded in a ROM 262 or a storage device 267, thereby implementing the functions of the client apparatus 161 in the trading information providing system shown in FIG. 1. The programs include a web browser 330 configured to operate the client apparatus 161 as a web client. The web browser 330 transmits/receives data such as account transfer data or processing result data to/from the server apparatus 101. In addition, the programs may include a cooperation application configured to exchange account transfer data and processing result data with an in-house centralized management system 350. The in-house centralized management system 350 actually executes the processing of account transfer based on input account transfer data, and outputs processing result data representing the execution result. Note that the rest of the arrangement of the client apparatus 161 is the same as the above-described arrangement of the client apparatus 151, and a description thereof will be omitted.

(Series of Operations Concerning Display of Account Transfer Data and Registration of New Account Transfer Data)

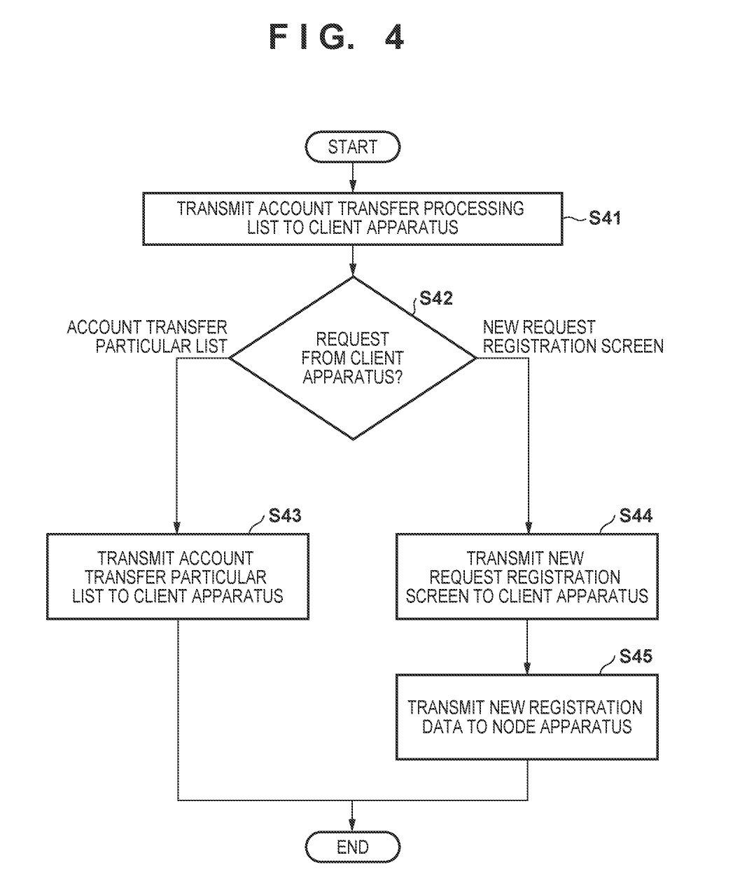

A series of operations of the server apparatus 101 concerning display of account transfer data and registration of new account transfer data by a user (business operator) will be described next with reference to FIG. 4. Note that in the following explanation, a person who operates a client apparatus will be referred to as an operator for the purpose of distinction from a user.

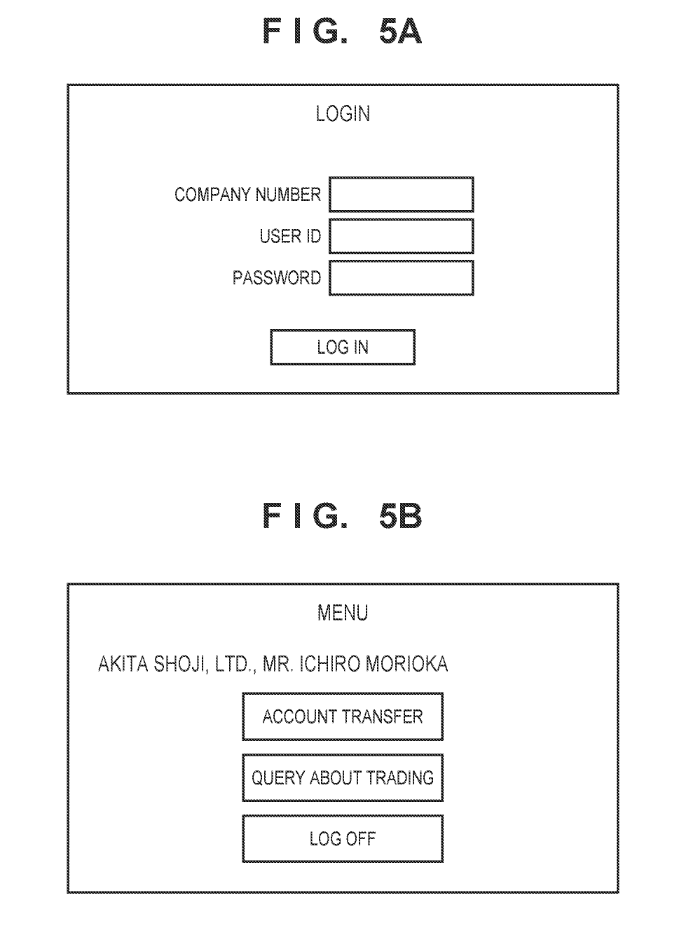

In addition, this processing is started when the operator logs in to a login screen (for example, FIG. 5A) in advance and selects “account transfer” on a menu screen (for example, FIG. 5B) on the client apparatus 151. That is, assume that when logging in, the operator logs in by inputting a correct combination of identification information and a password which specify the user and the operator, and if the server apparatus 101 confirms the authenticity, the menu screen is displayed. For example, in the example shown in FIG. 5A, the user (business operator) is specified by a company number, and the operator is specified by a user ID. Note that as for a password, any other information such as biometric authentication may be used as long as it is information for confirming the authenticity of the user or operator.

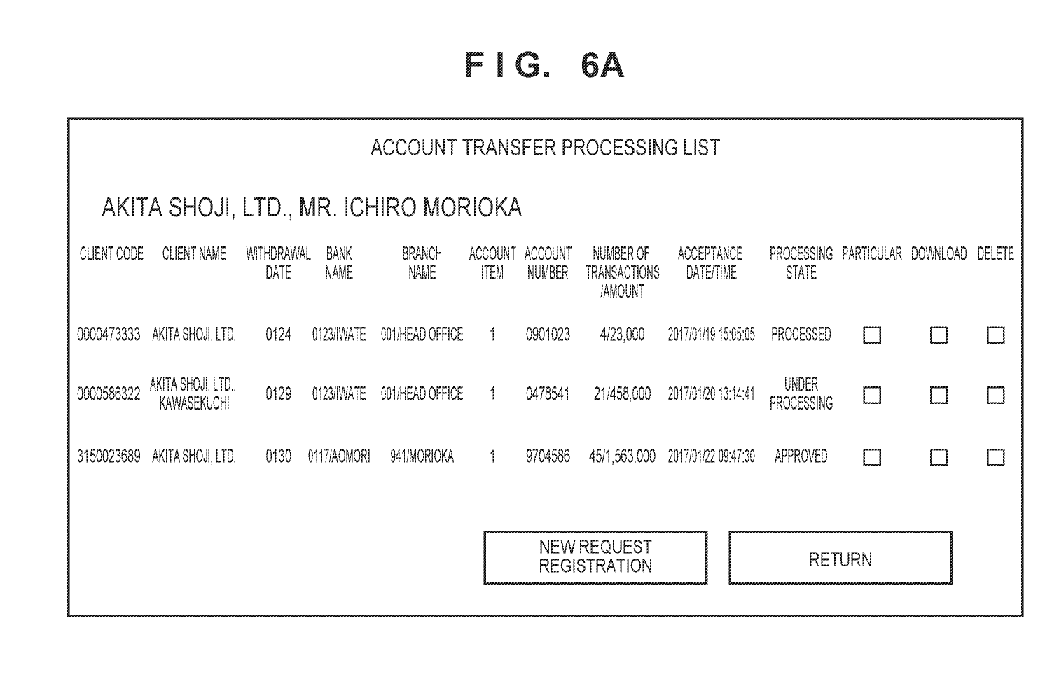

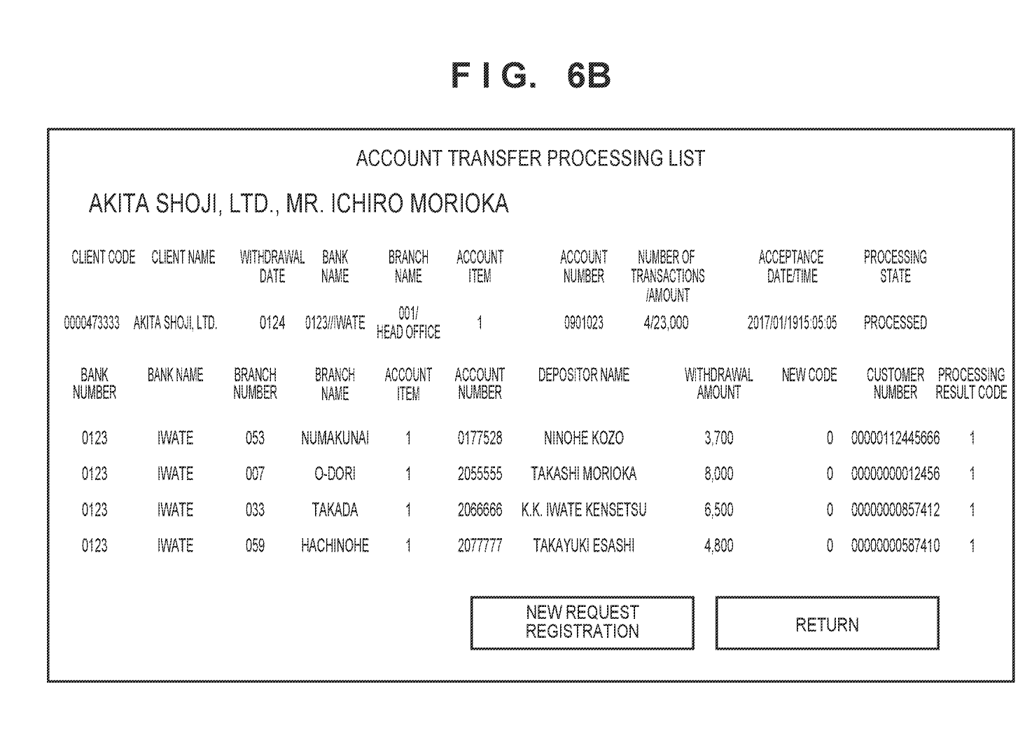

In step S41, the server apparatus 101 acquires information concerning an account transfer processing list from a node apparatus (for example, the node apparatus 102), and transmits it to the client apparatus 151 as a web page of the account transfer processing list (for example, FIG. 6A). More specifically, to acquire the information from the node apparatus, the server apparatus 101 designates, for example, information (here, the company number) for specifying the user, a predetermined period representing the range of account transfer data to be acquired, and the like and transmits an account transfer data acquisition request to the node apparatus. At this time, the server apparatus 101 may acquire information from one specific node apparatus or may acquire information, on a financial institution basis, from a node apparatus managed by each financial institution in which the user holds a trading account. When recording trading information, the node apparatus (for example, the node apparatus 102) may generate search metadata that enables the search of encrypted data in the distributed ledger and hold the metadata in the distributed ledger together with the trading information. For example, when holding data in a key-value store, the search metadata may be made to correspond to a key portion, and the trading information may be made to correspond to a value portion. For example, the CPU 211 of the node apparatus 102 executes the service program, thereby acquiring trading information according to a search request from the server apparatus 101 using the search metadata. In addition, the node apparatus 102 holds a table in which information for specifying a user and a financial institution in which the user has a trading account are associated in advance and the encryption key of each financial institution in, for example, the storage device 217. The CPU 211 of the node apparatus 102 executes the service program, thereby specifying the financial institution associated with the user using the table and acquiring the encryption key of the financial institution, and decrypting the account transfer data of the distributed ledger using the acquired encryption key.

Upon receiving a response from the node apparatus 102, the server apparatus 101 creates a web page to display the acquired account transfer data, which is a web page on which operations such as detailed information acquisition, selective download, and deletion can be performed for each piece of account transfer data. As shown in FIG. 6A, account transfer data displayed on the web page includes information such as an entrusted financial institution, the number of transactions that are account transfer targets, a total amount, and a processing state. If the user who is the subject of this processing entrusts account transfer to a plurality of financial institutions, the account transfer data of the plurality of financial institutions are included in the account transfer processing list.

In addition, “processing state” represents the processing state of account transfer data by a financial institution. For example, a state in which the user newly registers account transfer data on the blockchain is expressed as “unprocessed”, and a state in which a financial institution locks account transfer data to inhibit change and cause the centralized management system to actually execute account transfer is expressed as “under processing”. In addition, a state in which account transfer is actually executed by the centralized management system is expressed as “processed”, and a state in which the user approved unprocessed account transfer data is expressed as “approved”, or the like.

Note that upon receiving an acquisition request of information concerning the account transfer processing list, the node apparatus (for example, the node apparatus 102) acquires the encryption key of each financial institution associated with the user from a management server (not shown) or the node apparatus itself, decrypts the account transfer data of the distributed ledger using the acquired encryption key, and reads out the account transfer data within a designated range.

In step S42, the server apparatus 101 receives a request according to an operation on the web page of the account transfer processing list from the client apparatus 151, and determines the contents of the request. If the contents of the request represent display of an account transfer particular list, the server apparatus 101 advances to step S43. If the contents of the request represent new request registration, the server apparatus 101 advances to step S44.

In step S43, for one of the account transfer data displayed on the account transfer processing list, the server apparatus 101 acquires more detailed information from the node apparatus and creates a web page to display the account transfer particular list. More specifically, the server apparatus 101 transmits information for identifying the designated account transfer data to, for example, the node apparatus 102, and acquires detailed account transfer data associated with the corresponding account transfer data. In the display of the account transfer particular list, for example, as shown in FIG. 6B, account transfer data selected in the account transfer processing list and a plurality of pieces of account transfer data associated with the selected account transfer data are displayed. The server apparatus 101 transmits the web page of the account transfer particular list to the client apparatus 151 and ends the series of processes.

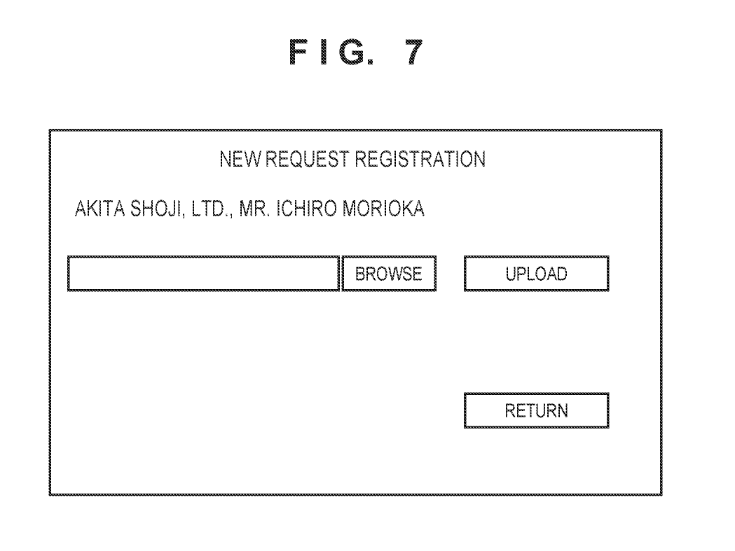

In step S44, the server apparatus 101 creates a web page of new request registration shown in, for example, FIG. 7, and transmits it to the client apparatus 151. On the new request registration page, the operator can select a file in which piece of account transfer data is recorded in, for example, the CSV format as new registration data to be registered on the blockchain. When the operator presses the “upload” button, the client apparatus transmits the file to the server apparatus 101.

In step S45, upon receiving the new registration data from the client apparatus 151, the server apparatus 101 performs addition request to add the contents of the data to the node apparatus 102. The server apparatus 101 transmits an addition request to add the new registration data to the node apparatus (for example, the node apparatus 102) together with the information for specifying the user. Upon receiving the addition request of trading information from the server apparatus 101, the node apparatus 102 writes, in the distributed ledger, account transfer data encrypted using the encryption key of the financial institution associated with the user. For example, the CPU 211 of the node apparatus 102 executes the service program, thereby specifying the financial institution associated with the user using the above-described table, acquiring the encryption key of the financial institution, and encrypting the account transfer data using the encryption key. At this time, the CPU 211 of the node apparatus 102 may generate search metadata that enables the search of encrypted data in the distributed ledger and store the metadata in the distributed ledger together with the trading information.

Note that on the blockchain, the node (for example, the node apparatus 102) that adds a transaction generates data (that is, a signature) in which the transaction is encrypted using a private key managed by the node itself and adds the data to the transaction. When other node apparatuses confirm the authenticity of the signature using a public key of the node apparatus that has added the transaction, the transaction is prevented from being altered. In addition, when the hash of a data block to which a plurality of transactions are added is calculated and stored in an adjacent data block, the data block is prevented from being altered.

Additionally, in this embodiment, since, for example, the PBFT (Practical Byzantine Fault Tolerance) method is employed as the consensus algorithm of the blockchain, the consensus algorithm can be executed at a high speed as compared to a case in which a method such as Proof of Work is employed. Accordingly, the record of the account transfer data in the distributed ledger is completed more quickly. For this reason, after the account transfer data is registered on the blockchain, the account transfer data after registration can be displayed more quickly.

When the registration of the new registration data by the node apparatus 102 is completed, the server apparatus 101 ends the series of processes.

(Series of Operations Concerning Download of Account Transfer Data and Registration of Processing Result Data by Financial Institution)

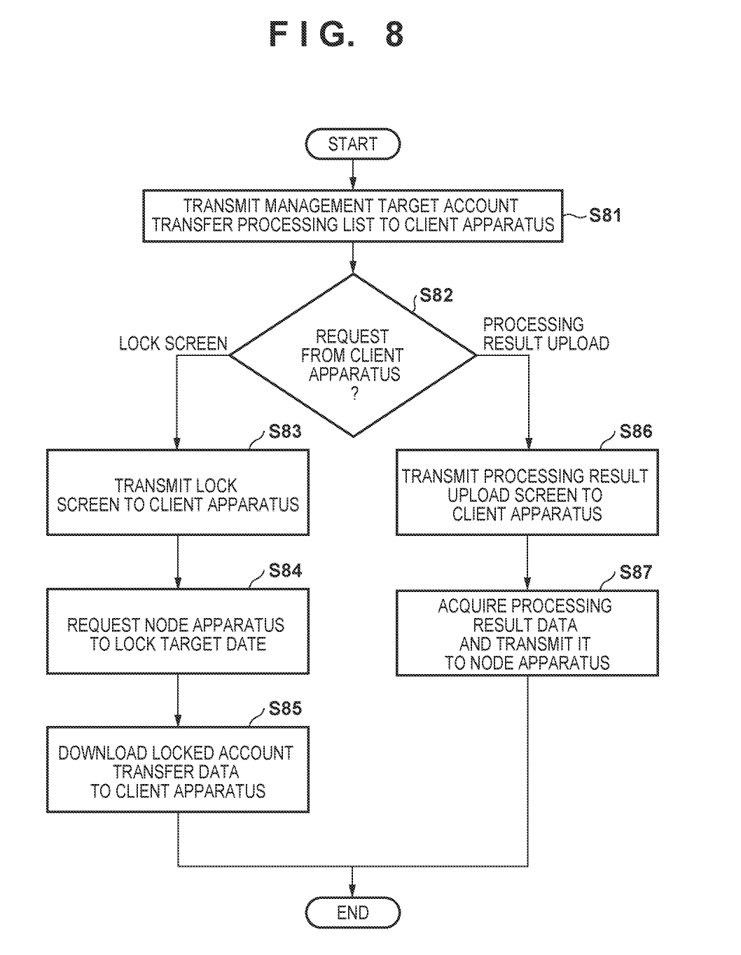

A series of operations of the server apparatus 101 concerning download of account transfer data and registration of processing result data by a financial institution will be described next with reference to FIG. 8.

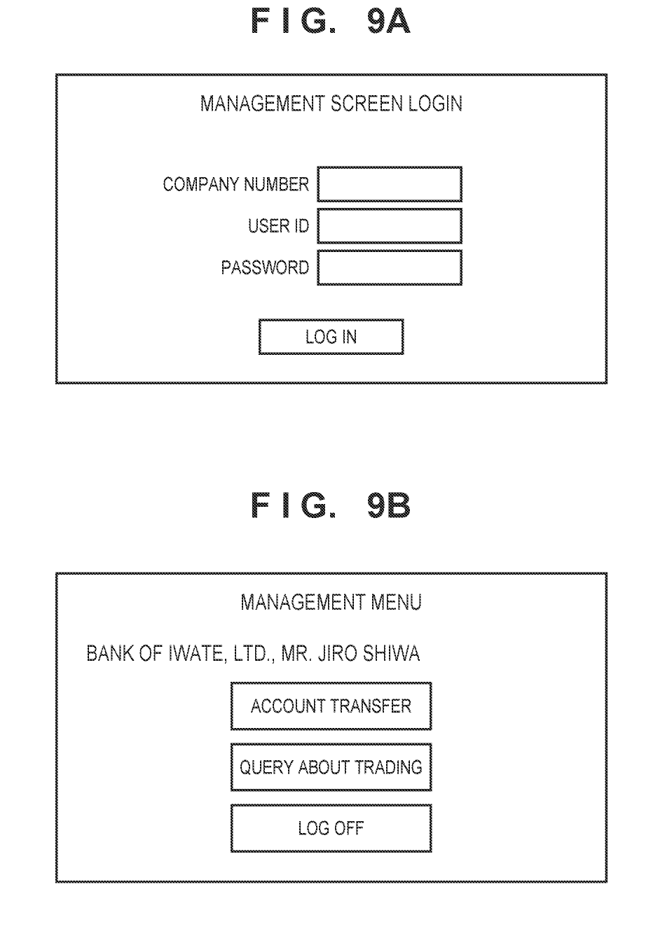

Note that this processing is started when the operator in the financial institution logs in using management screen login (for example, FIG. 9A) in advance and selects “account transfer” on a management menu screen (for example, FIG. 9B) on the client apparatus 161. That is, assume that when logging in, the operator logs in by inputting a correct combination of identification information and a password which specify the financial institution and the operator, and the menu screen is displayed. For example, in the example shown in FIG. 9A, the financial institution is specified by a company number, and the operator is specified by a user ID. Note that as for a password, any other information such as biometric authentication may be used as long as it is information for confirming the authenticity of the user or operator, as in the example described with reference to FIG. 4.

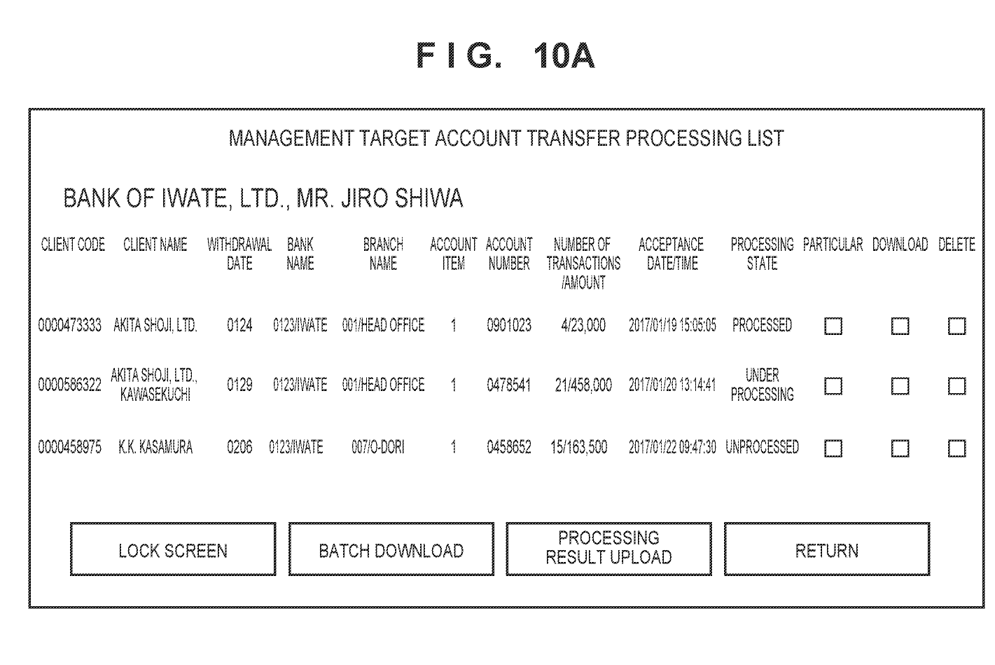

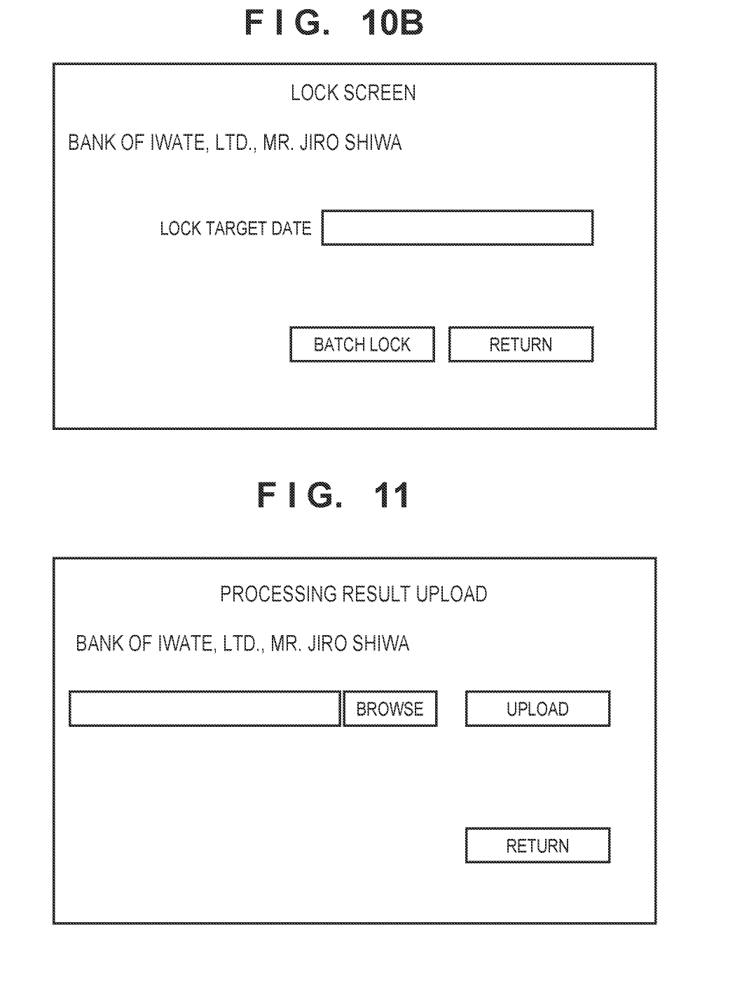

In step S81, the server apparatus 101 acquires information concerning an account transfer processing list from a node apparatus (for example, the node apparatus 102) managed by a financial institution, and transmits it to the client apparatus 161 as a web page of the management target account transfer processing list (for example, FIG. 10A). The server apparatus 101 designates, for example, identification information (here, the company number) for specifying the financial institution, a predetermined period representing the range of account transfer data to be acquired, and the like and transmits an account transfer data acquisition request to the node apparatus 102.

Note that upon receiving the acquisition request of information concerning the management target account transfer processing list, the node apparatus (for example, the node apparatus 102) decrypts the data of the distributed ledger using an encryption key associated with the financial institution, and reads out account transfer data within the designated range.

Upon receiving a response from the node apparatus 102, the server apparatus 101 creates a web page to display the acquired account transfer data, which is a web page on which operations such as detailed information acquisition, selective download, and deletion can be performed for each piece of account transfer data. As shown in FIG. 10A, account transfer data displayed on the web page includes information such as a client name, an account number as an account transfer target, the number of transactions, and a processing state. The account transfer processing list includes the account transfer data of a plurality of clients (that is, users).

In step S82, the server apparatus 101 receives a request according to a user operation on the web page of the management target account transfer processing list from the client apparatus 161, and determines the contents of the request. If the contents of the request represent display of a lock screen, the server apparatus 101 advances to step S83. If the contents of the request represent result upload, the server apparatus 101 advances to step S84.

In step S83, the server apparatus 101 creates a web page of a lock screen (FIG. 10B) on which a specific target date to lock account transfer data can be designated, and transmits it to the client apparatus 161. In step S84, upon receiving, from the client apparatus 161, a batch lock request in which a lock target date is designated, the server apparatus 101 requests the node apparatus 102 not to update the account transfer data of the designated lock target date. The node apparatus 102 controls to, for example, change information representing the processing state of the account transfer data to “lock state” and inhibit the account transfer data whose processing state “lock state” from being updated.

In step S85, upon receiving a request to download the locked account transfer data at once from the client apparatus 161, the server apparatus 101 acquires the account transfer data whose processing state is “lock state” from the node apparatus 102. The server apparatus 101 transmits the acquired account transfer data in a file format such as the CSV format to the client apparatus 161. When the transmission of file is completed, the server apparatus 101 ends the series of operations.

In step S86, upon receiving a processing result upload request from the client apparatus 161, the server apparatus 101 generates a web page of a processing result upload screen (for example, FIG. 11) and transmits it to the client apparatus 161.

In step S87, upon receiving processing result data from the client apparatus 161, the server apparatus 101 performs an addition request to add the contents of the data to the node apparatus 102. The server apparatus 101 transmits the processing result data and an addition request to add the processing result data to the node apparatus (for example, the node apparatus 102) managed by the financial institution of the transmission source. The node apparatus 102 writes, in the distributed ledger, account transfer data encrypted using the encryption key of the financial institution. The processing state of the account transfer data included in the processing result data thus changes to “processed”. After that, the server apparatus 101 ends the series of processes associated with this processing.

As described above, each of a plurality of node apparatuses managed by different financial institutions holds both the account transfer data of users in the financial institution itself and the account transfer data of users in other financial institutions. In addition, when an account transfer data acquisition request is received from the client apparatus of a user, the account transfer data of the user in the plurality of financial institutions are transmitted to the client apparatus. With this arrangement, the plurality of financial institutions can share the system (operational burden per financial institution can be reduced), and it is possible to provide account transfer data provided by the plurality of financial institutions to the user at once. In addition, each piece of account transfer data is encrypted using the encryption key of each financial institution when the data is written in the distributed ledger. With this arrangement, even if the plurality of financial institutions share the system, the information of a financial institution can be inhibited from being disclosed to the remaining financial institutions.

Note that in the above-described embodiment, an example in which account transfer data is handled as an example of trading information has been described. However, the above-described system can also be applied to any other information of the user in the financial institution. In addition, an example in which Hyperledger Fabric is used as a blockchain base to share the account transfer data of the plurality of financial institutions has been described. However, any other blockchain base can be used as long as the account transfer data can be distributively shared by the node apparatuses without disclosing the account transfer data of a financial institution to the remaining financial institutions. Furthermore, if the same as what is described above can be implemented, the blockchain need not be used.

### OTHER EMBODIMENTS

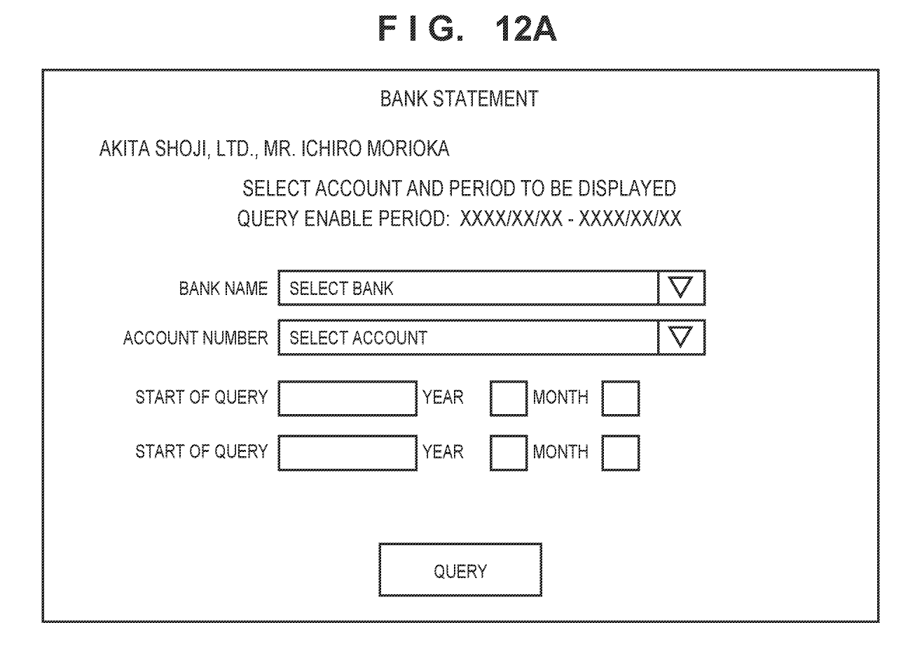

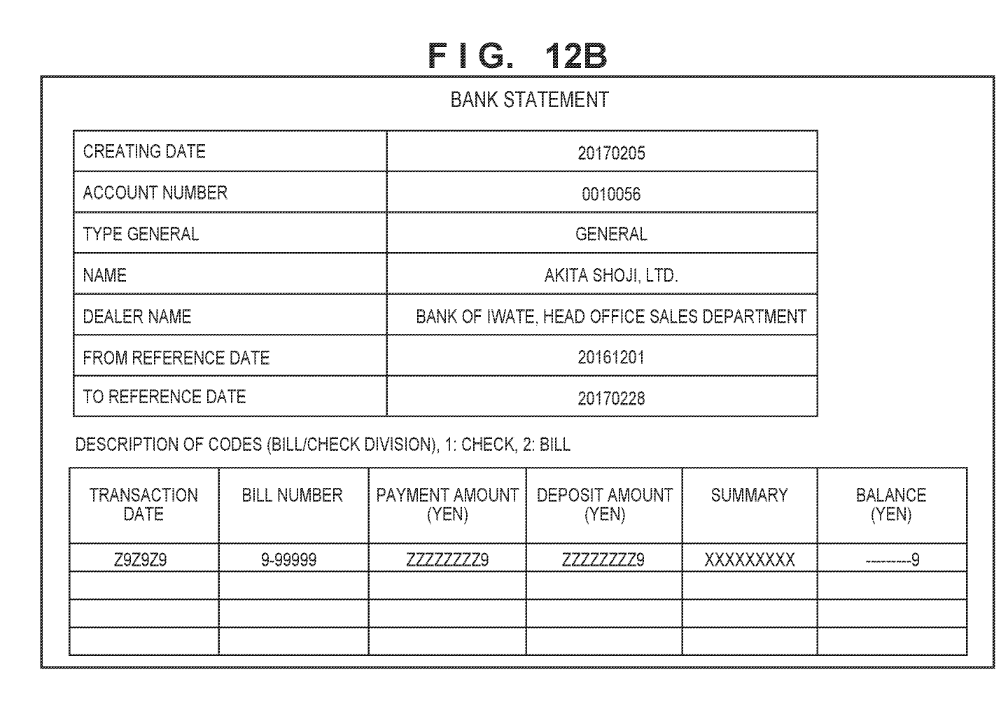

The above-described embodiment may have an arrangement that outputs a bank statement in addition to processing for account transfer data. In an example of bank statement output according to this embodiment, trading data (to be simply referred to as bank statement data) associated with a current account is displayed based on information designated by a user (business operator). Note that it is possible for a financial institution to record bank statement data on a blockchain by the same method as the processing result upload of account transfer data described in the first embodiment. Hence, a description of processing of registering bank statement data on the blockchain will be omitted, and processing of, by the server apparatus 101, receiving a query request from the client apparatus 151 via a bank statement output screen (FIG. 12A) used to set the bank statement and outputting the bank statement will be described.

The server apparatus 101 receives a query request from the client apparatus 151. Since the query request includes a bank name, an account number, and a query range (the query start and the query end) which are set on the bank statement output screen, the server apparatus 101 designates the parameters and requests the node apparatus 102 to acquire information.

Note that upon receiving the information acquisition request from the server apparatus 101, the node apparatus (for example, the node apparatus 102) decrypts the account transfer data of the distributed ledger using the encryption key of the financial institution associated with the user and reads out trading data within the designated range.

Upon acquiring trading data concerning the designated bank name, account number, and the like from the node apparatus 102, the server apparatus 101 transmits a web page in a format of a bank statement (for example, FIG. 12B) including the trading data to the client apparatus 151. The trading data displayed on the web page includes an account number, a dealer name, and the like and a check number, deposit and withdrawal amounts, a balance, and the like, as shown in FIG. 12B.

Trading data associated with a current account can be managed on a distributed ledger shared by a plurality of financial institutions in this way, and the user can easily acquire the bank statements of the plurality of financial institutions. When the distributed ledger is shared by the plurality of financial institutions, the risk of service stop caused by maintenance of concealment, a system failure, or the like can be suppressed, and burdens of development cost or operation cost per financial institution can be reduced.

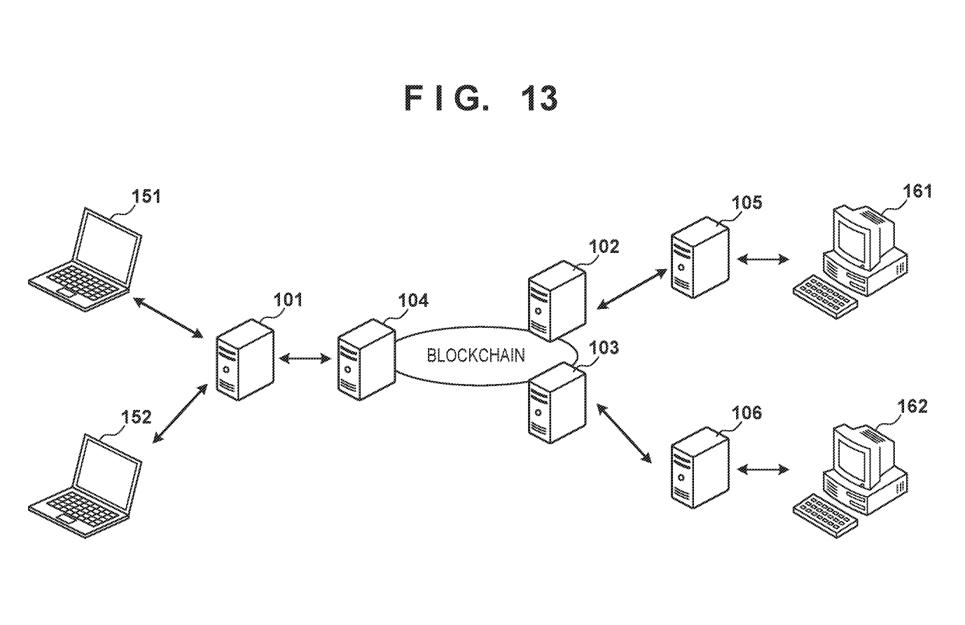

In the above-described embodiment, an example has been described in which the trading information providing system includes one server apparatus 101, and the server apparatus communicates with the client apparatuses 151 and 152 and the client apparatuses 161 and 162. However, the trading information providing system may include a plurality of server apparatuses having the same arrangement as that of the server apparatus 101, as shown in, for example, FIG. 13. For example, the trading information providing system includes three server apparatuses, that is, server apparatuses 101, 105, and 106. The server apparatus 101 communicates with the client apparatuses managed by the users and a node apparatus 104 (or an arbitrary node apparatus), and executes processing associated with the above-described account transfer data display or new account transfer data registration by the CPU. On the other hand, the server apparatus 105 performs communication between the node apparatus 102 and the client apparatus 161 managed by the financial institution B1, and executes processing associated with the above-described account transfer data download or processing result data registration by a financial institution (for example, B1) by the CPU. In addition, the server apparatus 106 performs communication between the node apparatus 103 and the client apparatus 162 managed by the financial institution B2, and executes processing of the above-described account transfer data download or processing result data registration by a financial institution (for example, B2) by the CPU. For example, the server apparatus 105 may be managed by the financial institution B1, and the server apparatus 106 may be managed by the financial institution B2. In this case, the server apparatus managed by each financial institution is connected to the node apparatus managed by the financial institution in a one-to-one correspondence.

When the server apparatus 105 and the server apparatus 106 are separately provided, the web application that generates the web page of a management target account transfer processing list or the like (in the account transfer data download and processing result data registration processing by the financial institution) described above can easily be made unique to each financial institution. This makes it easy to, for example, appropriately assign a necessary hardware resource to each financial institution or customize the display items, display layout, or the like of the management target account transfer processing list or the like. In other words, it is possible to reflect the performance requirement, quality requirement, and usability of each financial institution while allowing the plurality of financial institutions to share the trading information providing system.

In addition, when the server apparatus 101 and the server apparatus 105 are separately provided, the load when executing, in the server apparatus, processing of account transfer data display or new account transfer data registration and processing of account transfer data download or processing result data registration by a financial institution can be distributed. For example, when a financial institution downloads a large quantity of account transfer data associated with the financial institution to process the account transfer data at once, lowering of processing in a case in which an account transfer data display request is received for the client apparatus 151 can be suppressed. In addition, when server apparatuses corresponding to the financial institutions are provided, as in the example shown in FIG. 13, the influence of download processing by each financial institution on download processing by another financial institution can be reduced.

Note that the example shown in FIG. 13 shows a case in which the server apparatus 101, the server apparatus 105, and the server apparatus 106 are implemented separate pieces of hardware. That is, the operation of a server apparatus described assuming that each server apparatus is an operation entity is implemented when the CPU in each server apparatus executes a program recorded in the ROM. On the other hand, these server apparatuses may be implemented by a plurality of logical virtual machines. The plurality of logical virtual machines may be generated by a program executed using at least one integral hardware resource (including a data center formed by a plurality of devices including at least one CPU/GPU). It is also possible to increase a calculation resource needed in a case in which the load of the server apparatus increases.

Additionally, in the above-described embodiment, encryption and decryption of data of the distributed ledgers are controlled by the node apparatuses 102 and 103, thereby recording account transfer data of the plurality of financial institutions on the distributed ledger managed by each financial institution. However, control of encryption and decryption of data may be done not only by the node apparatuses but also by the server apparatus (or both the server apparatus and the node apparatuses). For example, in the example of the system shown in FIG. 13, in each of the server apparatus 101 and the server apparatuses 105 and 106, the CPU may execute encryption and decryption. For example, the server apparatus (for example, the server apparatus 105) encrypts data received from the client apparatus using the encryption key of the corresponding financial institution (for example, the financial institution B1), and transmits an addition request to the node apparatus 102 (or another node apparatus) together with the encrypted data. The node apparatus 102 receives the encrypted data and writes it in the distributed ledger of the storage device provided in the node apparatus 102. In addition, upon receiving data from the client apparatus 162, the server apparatus 106 similarly encrypts the data using the encryption key of the associated financial institution, and transmits the data together with an addition request to the node apparatus 103. The node apparatus 103 that receives the encrypted data records it in the distributed ledger of the storage device. The load of encryption and decryption can thus be distributed.

At this time, the server apparatus 105 may generate search metadata that enables the search of encrypted data in the distributed ledger and provide the search metadata to the corresponding node apparatus 102, and the node apparatus 102 may record the search metadata in the distributed ledger together with the encrypted data. The search metadata can include data that enables the search without causing the node apparatus to decrypt the encrypted data every time, for example, a date/time, information for specifying a financial institution, information (for example, a company number) for specifying a user, and the like. The node apparatus 102 may further encrypt the search metadata and record it (at the time of a search, the search metadata is decrypted, and the search is performed). On the other hand, when reading out data from the distributed ledger, the node apparatus 102 reads out data according to a request from the distributed ledger using the search metadata or the like by the CPU. The readout data is transmitted to the server apparatus 105. The server apparatus 105 decrypts the received data using the encryption key of the financial institution B1 by the CPU. Note that the encryption key of the financial institution may be, for example, stored in the storage device of at least one server apparatus and provided to another server apparatus. Alternatively, each server apparatus may acquire the encryption key of a necessary financial institution from a specific key management server (not shown).

Additionally, after the server apparatus 105 managed by the financial institution B1 encrypts data received from the client apparatus 161 using the encryption key of the financial institution B1, the node apparatus 102 managed by the financial institution B1 may receive the encrypted data, decrypt it using the encryption key of the financial institution B1, perform predetermined processing, encrypt the data again using the same encryption key, and record the data in the distributed ledger. At this time, the node apparatus 102 temporarily decrypts the received data and executes processing according to the contents of the received data using a control program (for example, a smart contract) operating on the node apparatus 102 by the CPU. At this time, the above-described search metadata may be stored together in the distributed ledger of the storage device. At this time, to perform encryption or decryption using the encryption key of the financial institution B1, the node apparatus 102 may, for example, receive the encryption key of the financial institution from the server apparatus 105 and discard the encryption key after the end of encryption or decryption processing. Similarly, when the node apparatus 102 reads out data from the distributed ledger and transmits it to the server apparatus 105, the node apparatus 102 performs decryption and encryption.

Furthermore, when the server apparatus 101 receives, from the client apparatus 151, an acquisition request to account transfer data recorded in the distributed ledger, the server apparatus 101 acquires the encryption keys of the financial institutions (for example, the financial institutions B1 and B2) associated with the user U1. At this time, the server apparatus 101 stores a table that associates information for specifying a user and a financial institution in which the user has a trading account in, for example, the storage device 207. In addition, the server apparatus 101 transmits an account transfer data acquisition request to the node apparatus 104 (or another node apparatus) using the period of data to be searched for, information of a search target financial institution, and the like as the search conditions. The node apparatus 104 or another node apparatus performs the search corresponding to the search condition using search metadata, reads out the encrypted account transfer data 185 from the distributed ledger, and transmits the readout data to the server apparatus 101. At this time, the account transfer data that the server apparatus 101 acquires from the node apparatus includes the data of the financial institutions B1 and B2. The server apparatus 101 decrypts the account transfer data using the encryption keys of the financial institutions (for example, the financial institutions B1 and B2) linked with the above-described user U1, and transmits the decrypted account transfer data to the client apparatus 151. Note that the node apparatus may read out the encrypted account transfer data that meets a predetermined condition, temporarily decrypt the data, and acquire account transfer data meeting the search conditions by the control program. Even by this method, the plurality of financial institutions can share the system, and the user can acquire account transfer data in the financial institutions to which the account transfer is entrusted at once.

Note that in the above-described embodiments, an example in which trading information is encrypted and decrypted using the key of a financial institution has been described. However, the method of encryption and decryption is not limited to this. For example, trading information in the financial institution B1 may be encrypted using some encryption key A, and the encryption key A may be encrypted using an encryption key associated with the financial institution B1. To refer to the trading information, the encryption key A is acquired using the encryption key associated with the financial institution B1, and the trading information is decrypted using the encryption key A. That is, the trading information in the financial institution B1 is concealed such that it can be referred to using the encryption key of the financial institution B1, and cannot be referred to for another financial institution.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2017-083703, filed Apr. 20, 2017, and No. 2018-042248, filed Mar. 8, 2018 which are hereby incorporated by reference herein in their entirety.

What is claimed is:

1. A trading information providing system including a plurality of node apparatuses, a server apparatus, and a user terminal,
wherein the plurality of node apparatuses are a plurality of node apparatuses managed by different financial institutions, and each of the plurality of node apparatuses comprises:
a storage device configured to hold both trading information of a user in a financial institution that manages the node apparatus and trading information of the user in a financial institution that does not manage the node apparatus; and
at least one processor or circuit configured to perform the operations of following units:
a node reception unit configured to receive, from the server apparatus, a first acquisition request for the trading information of the user who has a trading account in a financial institution of the plurality of financial institutions;
a read unit configured to read out, from the storage device, trading information according to the first acquisition request received by the node reception unit; and
a node transmission unit configured to transmit the trading information of the user read out by the read unit to the server apparatus,
wherein the server apparatus comprises:
at least one processor or circuit configured to perform the operations of following units:
a server reception unit configured to receive, from the user terminal of the user, a second acquisition request for the trading information of the user;
an acquisition unit configured to acquire trading information according to the second acquisition request from at least one of the plurality of node apparatuses using the first acquisition request in accordance with reception of the second acquisition request by the server reception unit; and
a server transmission unit configured to transmit the acquired trading information according to the second acquisition request to the user terminal as a response, and
wherein the server transmission unit transmits the response including the trading information of the user in at least two financial institutions to the user terminal.

2. The system according to claim 1, wherein the storage device holds, by a blockchain, both the trading information of the user in the financial institution that manages the node apparatus and the trading information of the user in the financial institution that does not manage the node apparatus.

3. The system according to claim 1, wherein the at least one processor or circuit of each of the plurality of node apparatuses is further configured to perform the operations of a processing unit that processes the trading information of the user,
wherein the processing unit conceals the trading information of the user in a first financial institution such that the trading information can be referred to using an encryption key assigned to the first financial institution, and conceals the trading information of the user in a second financial institution such that the trading information can be referred to using an encryption key assigned to the second financial institution, and
the storage device holds the trading information of the user in the first financial institution and the trading information of the user in the second financial institution, which are concealed by the processing unit.

4. The system according to claim 3, wherein in a case in which the user of the user terminal has the trading account in the first financial institution and the second financial institution, upon receiving the first acquisition request from the server apparatus, the processing unit decrypts the trading information of the user in the first financial institution, which is concealed such that the trading information can be referred to using the encryption key assigned to the first financial institution, and decrypts the trading information of the user in the second financial institution, which is concealed such that the trading information can be referred to using the encryption key assigned to the second financial institution, and
wherein the node transmission unit transmits the trading information of the user decrypted by the processing unit to the server apparatus.

5. The system according to claim 1, wherein the at least one processor or circuit of the server apparatus is further configured to perform the operations of an addition request unit,
wherein in accordance with reception of additional trading information from the user terminal by the server reception unit, the addition request unit transmits, to at least one of the plurality of node apparatuses, an addition request to add the additional trading information to the trading information held by the node apparatus, and
wherein the storage device of each of the plurality of node apparatuses adds the trading information concerning the addition request to the trading information held by the node apparatus in accordance with reception of the addition request.

6. The system according to claim 5, wherein the server reception unit further receives trading information whose trading state is changed from a second user terminal managed by a predetermined financial institution, and
in accordance with reception of the trading information whose trading state is changed from the second user terminal by the server reception unit, the addition request unit further transmits, to at least one of the plurality of node apparatuses, an addition request to add the trading information whose trading state is changed to the trading information held by the node apparatus.

7. The system according to claim 6, wherein the trading information whose trading state is changed is trading information whose trading state is changed by processing the trading in a centralized management system of the predetermined financial institution.

8. The system according to claim 1, wherein the server reception unit further receives an acquisition request for trading information in a predetermined financial institution from a second user terminal managed by the predetermined financial institution, and
wherein the acquisition unit acquires trading information according to the acquisition request of the trading information concerning the predetermined financial institution in accordance with reception of the acquisition request for the trading information from the second user terminal by the server reception unit.

9. The system according to claim 8, wherein the at least one processor or circuit of the server apparatus is further configured to perform the operations of a lock request unit,
wherein the lock request unit requests the plurality of node apparatuses not to change contents of predetermined trading information of the trading information held by each of the plurality of node apparatuses.

10. The system according to claim 1, wherein the at least one processor or circuit of the server apparatus is further configured to perform the operations of a processing unit that processes the trading information of the user,
wherein the processing unit conceals the trading information of the user in a first financial institution such that the trading information can be referred to using an encryption key assigned to the first financial institution, and conceals the trading information of the user in a second financial institution such that the trading information can be referred to using an encryption key assigned to the second financial institution, and
the server transmission unit further transmits, to at least one of the plurality of node apparatuses, the trading information of the user in the first financial institution and the trading information of the user in the second financial institution, which are concealed by the server apparatus.

11. The system according to claim 1, further comprising a second server apparatus that is different from the server apparatus and is managed by a predetermined financial institution,
wherein the second server apparatus comprises:
at least one processor or circuit configured to perform the operations of following units comprising:
a second server reception unit configured to receive trading information whose trading state is changed from a second user terminal managed by the predetermined financial institution; and
an addition request unit configured to, in accordance with reception of the trading information whose trading state is changed by the second server reception unit, transmit, to a node apparatus managed by the predetermined financial institution in the plurality of node apparatuses, an addition request to add the trading information whose trading state is changed to the trading information held by the node apparatus, and
the storage device of each of the plurality of node apparatuses adds the trading information concerning the addition request to the trading information held by the node apparatus in accordance with reception of the addition request.

12. The system according to claim 11, wherein the at least one processor or circuit of the second server apparatus is further configured to perform the operations of a second processing unit, and
wherein in accordance with reception of the trading information whose trading state is changed by the second server reception unit, the second processing unit conceals the trading information such that the trading information can be referred to using an encryption key assigned to the predetermined financial institution.

13. The system according to claim 1, wherein the trading information is information of account transfer.

14. A server apparatus configured to communicate with a plurality of node apparatuses managed by different financial institutions and configured to hold both trading information of a user in a financial institution that manages the node apparatus and trading information of the user in a financial institution that does not manage the node apparatus, comprising:
at least one processor or circuit configured to perform the operations of following units:
a reception unit configured to receive an acquisition request for the trading information of the user from a user terminal of the user who has a trading account in a financial institution of a plurality of financial institutions;
an acquisition unit configured to acquire the trading information according to the acquisition request from at least one of the plurality of node apparatuses in accordance with reception of the acquisition request; and
a transmission unit configured to transmit the acquired trading information according to the acquisition request to the user terminal as a response, and
wherein the transmission unit transmits the response including the trading information of the user in at least two financial institutions to the user terminal.

15. A method of controlling a server apparatus configured to communicate with a plurality of node apparatuses that are managed by different financial institutions and that are configured to hold both trading information of a user in a financial institution that manages the node apparatus and trading information of the user in a financial institution that does not manage the node apparatus, comprising:
receiving an acquisition request for the trading information of the user from a user terminal of the user who has a trading account in a financial institution of a plurality of financial institutions;
acquiring the trading information according to the acquisition request from at least one of the plurality of node apparatuses in accordance with reception of the acquisition request; and
transmitting the acquired trading information according to the acquisition request to the user terminal as a response,
wherein in the transmitting, the response including the trading information of the user in at least two financial institutions is transmitted to the user terminal.

16. A node apparatus in a system including a plurality of node apparatuses managed by different financial institutions and configured to hold both trading information of a user in a financial institution that manages the node apparatus and trading information of the user in a financial institution that does not manage the node apparatus, and a server apparatus configured to, in accordance with reception of an acquisition request for the trading information of the user from a user terminal of the user who has a trading account in a financial institution of a plurality of financial institutions, acquire trading information according to the acquisition request from at least one of the plurality of node apparatuses and transmit a response including the trading information of the user in at least two financial institutions to the user terminal, comprising:
a storage device configured to hold both the trading information of the user in the financial institution that manages the node apparatus and the trading information of the user in the financial institution that does not manage the node apparatus; and
at least one processor or circuit configured to perform the operations of following units:
a reception unit configured to receive, from the server apparatus, the acquisition request for the trading information of the user;
a read unit configured to read out, from the storage device, the trading information according to the acquisition request received by the reception unit; and
a transmission unit configured to transmit the trading information of the user read out by the read unit to the server apparatus.

17. A method of controlling a node apparatus in a system including a plurality of node apparatuses managed by different financial institutions and configured to hold both trading information of a user in a financial institution that manages the node apparatus and trading information of the user in a financial institution that does not manage the node apparatus, and a server apparatus configured to, in accordance with reception of an acquisition request for the trading information of the user from a user terminal of the user who has a trading account in a financial institution of a plurality of financial institutions, acquire trading information according to the acquisition request from at least one of the plurality of node apparatuses and transmit a response including the trading information of the user in at least two financial institutions to the user terminal, comprising:
holding both the trading information of the user in the financial institution that manages the node apparatus and the trading information of the user in the financial institution that does not manage the node apparatus;
receiving, from the server apparatus, the acquisition request for the trading information of the user;
reading out, from the held trading information, the trading information according to the received acquisition request; and
transmitting the readout trading information of the user to the server apparatus.
